(19) United States
(12) Patent Application Publication
(10) Pub. No.: US 2024/0415723 A1
(43) Pub. Date: Dec. 19, 2024

(54) Walking Frame with Self-Aligning Wheels

(71) Applicant: Nottingham Rehab Limited, Coalville, Leicestershire (GB)

(72) Inventors: Callum Matthew Jack WATT, Salford, Greater Manchester (GB); Sibylle Brunhilde Anitha THIES, Salford, Greater Manchester (GB); Jithin Karukasseril VIJAYAN, Coalville, Leicestershire (GB); Susan Bevan, Coalville, Leicestershire (GB)

(21) Appl. No.: 18/712,590

(22) PCT Filed: Nov. 28, 2022
(86) PCT No.: PCT/GB2022/053002

§ 371 Date: May 22, 2024

(30) Foreign Application Priority Data
Nov. 29, 2021 (GB) 2117186.3

(51) Int. Cl. A61H 3/04; B60B 33/02

(52) U.S. Cl. CPC A61H 3/04; B60B 33/028; A61H 2003/046; A61H 2201/1635

(57) ABSTRACT

A walking frame (100) comprising a walking frame body (110) configured to provide support to a user as they walk across a surface, at least one swivel castor (120a. 120b) coupled to the walking frame body (110) and comprising a wheel (122) configured to contact the surface and rotate and a wheel mount (124) rotatable with respect to the walking frame body (110) to change the orientation of the wheel (122) relative to the walking frame body (110) and allow the user to steer the walking frame (100). The walking frame (100) also comprises an alignment mechanism (130) configured to apply a biasing force to the wheel mount (124) on rotation thereof to bias the wheel (122) into a predetermined orientation relative to the walking frame body (110), wherein the biasing force applied to the wheel mount (124) decreases as the wheel mount (124) rotates away from the predetermined orientation.

The invention relates to a walking frame for supporting a user as they walk across a surface. More specifically, the invention relates to a walking frame having an alignment mechanism for biasing wheels of the walking frame into a predetermined orientation.

A walking frame is a mobility aid used by individuals who have reduced strength or stability that affects walking or standing. In use, the user holds onto handles of the walking frame and legs of the walking frame engage the ground to provide support to the user. Typical walking frames have feet, which are often rubberised, on the end of each leg to provide frictional grip on the ground. However, while useful when the user is static, such walking frames cause instability for the user as they walk, since the user must lift the walking frame when they are walking across the ground. The additional weight of the frame that the user needs to carry and the resulting shift in centre-of-gravity can be problematic for individuals with reduced strength or stability, and in some cases may exacerbate these issues further.

Modern walking frames often have one or more castors secured to the end of some of the legs (for example, the front legs). These castors enable the user to push the walking frame over the ground without lifting it. The castors can either be swivel or non-swivel castors.

Swivel castors advantageously allow the user to change direction when walking, while keeping the walking frame on the ground. The swivel castors rotate into the desired direction as the user turns. However, swivel castors have a tendency to change direction undesirably and sometimes they can oscillate undesirably during forward motion of the walking frame. This reduces the stability of the user while walking.

In contrast, non-swivel castors do not change direction or oscillate undesirably. However, non-swivel castors cannot turn when a user attempts to change direction, which means the walking frame must be picked up and rotated in the air as the user turns. This can be observed on higher-friction flooring, such as carpet in particular. Similarly to walking frames with feet, this leads to additional weight for the user to carry and a shift in the user's centre-of-gravity, leading to reduced stability while turning.

The present invention addresses the aforementioned problems with walking frames. More specifically, the present invention provides improved stability compared to a swivel castor and improved mobility and stability, particularly while turning, compared to a non-swivel castor.

### SUMMARY

According to an aspect of the invention, there is provided a walking frame as defined in claim 1.

The walking frame comprises a walking frame body configured to provide support to a user as they walk across a surface and at least one swivel castor coupled to the walking frame body. The at least one swivel castor comprises a wheel configured to contact the surface and rotate as the user pushes the walking frame across the surface and a wheel mount rotatable with respect to the walking frame body to change the orientation of the wheel relative to the walking frame body and allow the user to steer the walking frame in different directions across the surface. The walking frame further comprises an alignment mechanism configured to apply a biasing force to the wheel mount on rotation thereof to bias the wheel into a predetermined orientation relative to the walking frame body. The biasing force applied to the wheel mount decreases as the wheel mount rotates away from the predetermined orientation.

Advantageously, application of a biasing force to the wheel mount provides self-aligning wheels. The biasing force keeps the wheels facing in the predetermined orientation until the user wishes to change direction. That is, when in the predetermined orientation, the swivel castors may behave like non-swivel castors. This reduces shaking or wobbling of the wheels during motion, as the user walks across the surface, and therefore further improves the stability of the walking frame for the user when the user is walking in a direction corresponding to the predetermined orientation.

The predetermined orientation may correspond to the direction of the wheels when the walking frame moves in a forwards direction.

Advantageously, the biasing force decreasing as the wheel mount rotates away from the predetermined orientation allows an easy change of direction even though the wheel is able to improve the stability in the predetermined orientation. In other words, the stability is improved while in the predetermined orientation but when the user wishes to change direction, the biasing force reduces once they apply an initial force to turn the wheels, allowing the user to turn the walking frame easily. The claimed configuration thereby provides improved stability in, for example, the forwards direction, with a low resistance to a change of direction, further improving stability when the user wishes to turn.

The wheels may be conventional wheels used in walking frames. Alternatively, the wheels may have a diameter larger than the conventional wheels used in walking frames. For example, the wheels may have a diameter of 125 mm (rather than the 100 mm diameter that is often used in walking frames). Advantageously, the use of wheels of larger diameter provides improved stability to the walking frame. The wheel may rotate about an axis perpendicular to the axis of rotation of the wheel mount. The wheel may be rotatable about a horizontal axis relative to the wheel mount. The wheel mount may be rotatable about a vertical axis relative to the walking frame body.

Optionally, the alignment mechanism is configured to apply the biasing force to the wheel mount over a predetermined rotational range of the wheel mount.

Advantageously, the predetermined rotational range provides a range of orientations to which the user may rotate the wheel mount and in which the wheel mount will rotate back into the predetermined orientation by virtue of the biasing force. This provides a self-aligning functionality while the wheel mount is within the predetermined rotational range. The predetermined rotational range may be centred on the predetermined orientation. That is, the predetermined rotational range may encompass a predetermined angular displacement of the wheel mount in an anticlockwise direction from the predetermined orientation, and/or a predetermined angular displacement of the wheel mount in a clockwise direction from the predetermined orientation. The predetermined angular displacements in the anticlockwise and clockwise directions may be equal.

Optionally, the predetermined rotational range of the wheel mount is less than 360 degrees.

The predetermined rotational range may be any appropriate range such that the wheel mount self-aligns if the walking frame is inadvertently steered away from the predetermined orientation by a small amount. For example, the predetermined rotational range may be 5 degrees or less, 10 degrees or less, 20 degrees or less, 45 degrees or less, or 90 degrees or less.

Optionally, the alignment mechanism is configured to apply no biasing force to the wheel mount outside of the predetermined rotational range.

Advantageously, by providing a biasing force within the predetermined rotation range but no biasing force outside of the predetermined rotational range, the alignment mechanism provides a self-aligning functionality only when the walking frame is steered slightly away from the predetermined orientation, while providing substantially no resistance during a more deliberate change of direction. In other words, if the user accidentally deviates from the predetermined orientation by a small amount, the biasing force ensures that the wheel mounts return to the predetermined orientation. However, if the user intends to change direction, the biasing force is no longer present during the change of direction, allowing the user to change direction freely and easily without considerable effort to overcome large biasing forces to maintain a different orientation of the wheels from the predetermined orientation. When the wheel mounts are then returned to the predetermined rotational range, the biasing force returns to align the wheel mounts to the predetermined orientation.

Optionally, the alignment mechanism comprises a plurality of magnets configured to provide the biasing force to bias the wheel mount into the predetermined orientation. It will be appreciated that the strength and/or number of magnets can be chosen to provide appropriate characteristics (e.g. magnitude of biasing force and/or the size of the predetermined rotational range).

Optionally, the alignment mechanism comprises a first magnet coupled to the walking frame body and a second magnet coupled to the wheel mount and configured to rotate therewith, wherein relative rotation between the wheel mount and the walking frame body causes the biasing force to be applied to the wheel mount.

In other words, the magnetic interaction between the first magnet and the second magnet provides a biasing force when the wheel mount rotates away from the predetermined orientation. The first magnet and the second magnet may be separated by a gap to facilitate relative movement between the first magnet and the second magnet. The size of the gap may be chosen to control the strength of the magnetic interaction between the first magnet and the second magnet.

The first magnet and the second magnet may be considered to constitute a first pair of magnets. The alignment mechanism may comprise a plurality of pairs of magnets.

Each pair of magnets may be configured in the same way as the first magnet and the second magnet. Advantageously, the provision of further pairs of magnets can provide a plurality of predetermined orientations into which the wheel mount is biased. For example, the presence of two pairs of magnets would provide two predetermined orientations. The two pairs of magnets could be separated by an angle of 180 degrees, thereby providing predetermined orientations that are separated by an angle of 180 degrees. Further pairs may be provided to provide yet further predetermined orientations. In general, the presence of N pairs of magnets may be used to provide N predetermined orientations.

Optionally, opposing poles of the first and second magnets are aligned when the wheel mount is in the predetermined orientation.

In this context, by ‘aligned’ it is meant that the opposing poles are adjacent to one another and arranged to be in equilibrium, such that the magnetic force between the first and second magnets does not cause further movement of the wheel mount from the predetermined orientation.

Optionally, the first and second magnets are coaxial when the wheel mount is in the predetermined orientation.

The first and second magnets being coaxial means that the magnetic axis of the first magnet is parallel and coincident with the magnetic axis of the second magnet. The magnetic axis of a magnet is defined as the axis extending between the poles of the magnet. The first and second magnets may be coaxial along a vertical axis of the walking frame. The first and second magnets may be coaxial along an axis which is parallel to, and optionally offset from, the rotational axis of the wheel mount.

Optionally, the first and second magnets are coupled to the walking frame body and the wheel mount respectively in a position offset from a rotational axis of the wheel mount.

The magnetic axes of the first and second magnets may be parallel with and offset with respect to the rotational axis of the wheel mount.

Optionally, the walking frame comprises a plurality of swivel castors.

For example, the walking frame may comprise two, four, or six swivel castors.

Optionally, the walking frame body comprises front legs and rear legs, and wherein a swivel castor is coupled to each of the front legs and a low-friction glide for sliding over the surface is coupled to each of the rear legs.

For example, the walking frame body may comprise two front legs, with a swivel castor coupled to each of the two front legs. The walking frame body may comprise two rear legs, with a low-friction glide coupled to each of the two rear legs. The low-friction glide may comprise, or be formed of, a low-friction material, such as nylon. The nylon may be glass-filled (for example, substantially 10%-15%). In alternative arrangements, the low-friction glides may comprise, or be formed of, Acetal (polyoxymethylene or POM) or Polytetrafluoroethylene (PTFE).

Alternatively, the walking frame body may comprise swivel castors coupled to each of the front legs and each of the rear legs. Some or all of the swivel castors may comprise the alignment mechanism. For example, each of the front legs may comprise a swivel castor that comprises an alignment mechanism and each of the front legs may comprise a swivel castor without an alignment mechanism. In a further example, all of the legs may be coupled to a swivel castor having an alignment mechanism.

Optionally, the walking frame further comprises a brake configured to, upon actuation, provide increased resistance to the user pushing the walking frame across the surface.

The brake may be coupled to a wheel. In such embodiments, the brake may be configured to provide increased frictional resistance to rotation of the wheel. For example, the brake may comprise a clamp that, upon actuation, engages the wheel.

Alternatively or additionally, the brake may be coupled to a low-friction glide. In such examples, the brake may be configured to provide increased frictional resistance to sliding of the low-friction glide over the surface. For example, the brake may comprise a high-friction (relative to the rest of the low-friction glide) portion that is moveable into and out of contact with the surface over which the low-friction glides are sliding.

### BRIEF DESCRIPTION OF THE FIGURES

FIG. 1 is a perspective view of a walking frame;

FIG. 2A is a side view of a swivel castor for a walking frame;

FIG. 2B is a cross-sectional view of a portion of the swivel castor of FIG. 2A;

FIG. 2C is a schematic diagram showing an exemplary alignment mechanism;

FIG. 3A is a perspective view of a swivel castor with a wheel mount in a first orientation;

FIG. 3B is a perspective view of the swivel castor of FIG. 3A with the wheel mount in a second orientation; and

FIG. 3C is a perspective view of the swivel castor of FIG. 3A with the wheel mount in a third orientation.

### DETAILED DESCRIPTION

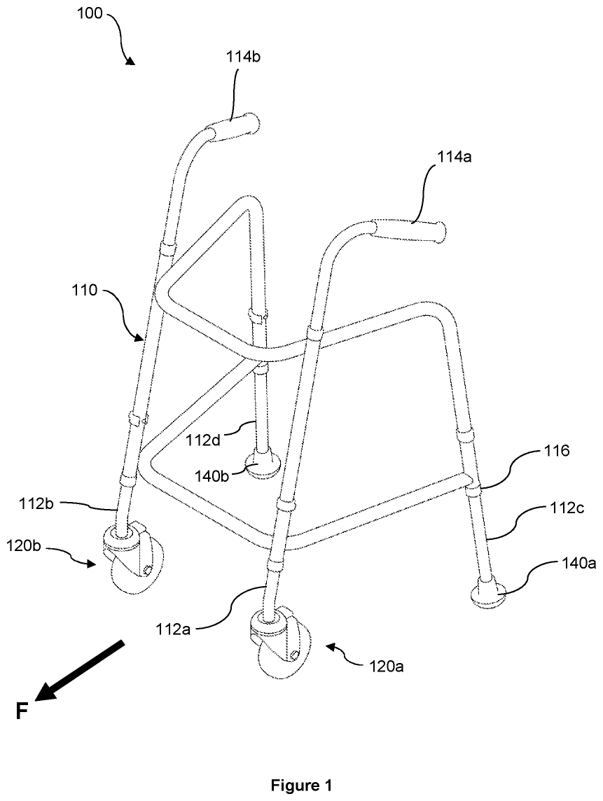

FIG. 1 shows an exemplary walking frame 100. The walking frame 100 comprises a walking frame body 110. The exemplary walking frame body 110 comprises four legs 112a-d for providing support to the walking frame body 110. The legs 112a-d are arranged to define four corners of the walking frame 100. As seen in FIG. 1, from a top view, the walking frame 100 has a substantially trapezoidal shape, with each leg 112a-d providing a corner of the trapezoid. It will be appreciated that different shapes are possible, such as square or rectangular, and that a different number of legs may be provided in alternative arrangements.

The legs 112a-d may comprise front legs 112a, b of the walking frame 100, which may be the forward-most legs when the walking frame 100 is in use. The legs 112a-d may comprise rear legs 112c, d, which may be rear-most legs when the walking frame 100 is in use. The walking frame body 110 may comprise handles 114a, b.

In use, the walking frame body 110 is arranged such that the legs 112a-d are directed towards a surface (e.g. the floor) and the handles 114a, b are disposed above the legs 112a-d for the user to hold. The walking frame 100 can be pushed across the surface by the user as the user walks across the surface. Arrow F indicates the direction of movement when the walking frame 100 is pushed forwards as the user walks.

The lengths of the legs 112a-d, and thus the height of the handles 114a, b above the surface, may be adjustable, for example at adjustment points 116. Any suitable length-adjustment mechanism known in the art may be used. While a specific arrangement of the walking frame body 110 is depicted in FIG. 1, it will be appreciated that many different configurations for a walking frame body are known in the art that could replace walking frame body 110.

The walking frame 100 further comprises a plurality of (in this case, two) swivel castors 120a, b. Swivel castor 120a is coupled to front leg 112a and swivel castor 120b is coupled to front leg 112b. The walking frame 100 further comprises a plurality of (in this case, two) low-friction glides 140a, 140b. Low-friction glide 140a is coupled to rear leg 112c and low-friction glide 140b is coupled to rear leg 112d. The low-friction glides 140a, b may be configured to provide relatively low frictional resistance between the low-friction glides 140a, b and the surface as the user pushes the walking frame 100 across the surface. In exemplary arrangements, the low-friction glides 140a, b may comprise, or be formed from, nylon. In exemplary arrangements, the low-friction glides 140a, b may comprise, or be formed from, nylon with glass fill (for example, with glass fill of substantially 10%-15%). In alternative arrangements, the low-friction glides may comprise, or be formed of, Acetal (polyoxymethylene or POM) or Polytetrafluoroethylene (PTFE).

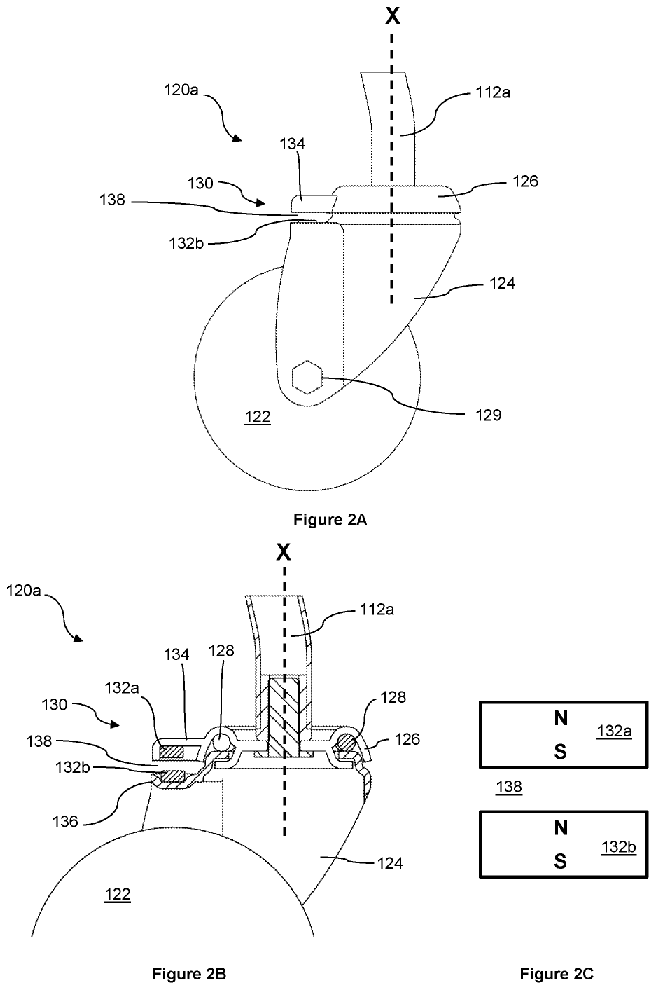

Turning to FIGS. 2A-2C, the structure of the swivel castors 120a, b will be described. FIG. 2A specifically depicts swivel castor 120a but it will be appreciated that equivalent structural features apply to swivel castor 120b (or any other swivel castors coupled to the walking frame in other arrangements).

The swivel castor 120a comprises a wheel 122 and a wheel mount 124. The wheel 122 may be mounted to the wheel mount 124, for example by way of an axle 129 passing through the wheel 122 and the wheel mount 124. The wheel mount 124 has an upturned-U shape, with the wheel 122 being disposed between the two branches of the upturned-U. The axle 129 passes from one branch, through the wheel 122, and to the other branch to couple the wheel 122 to the wheel mount 124.

The wheel 122 is rotatable relative to the wheel mount 124 as the user pushes the walking frame 100 across the surface. In the exemplary arrangement depicted in FIG. 2A, the wheel mount is rotatable about the axle 129.

The wheel mount 124 may be rotationally coupled to the walking frame body 110. In the exemplary arrangement of FIG. 2A, the wheel mount 124 is rotationally coupled to the walking frame body 110 via a collar 126.

The collar 126 may be coupled to, and rotationally fixed relative to, the walking frame body 110. In the exemplary arrangement of FIG. 2, the collar 126 is coupled to, and rotationally fixed relative to, the leg 112a. The wheel mount 124 may be rotationally coupled to the collar 126 and configured to rotate with respect to the collar 126 (and therefore the walking frame body 110). As seen in the cross-sectional view of FIG. 2B, there is a plurality of bearings 128 disposed between the wheel mount 124 and the collar 126 to facilitate the relative rotation therebetween. The skilled person will appreciate that alternative rotational mechanisms may be used in alternative arrangements. The skilled person will also appreciate that in alternative arrangements, a collar 126 may not be provided, and the wheel mount 124 may be directly rotationally coupled to the walking frame body 110.

The wheel mount 124 is rotatable about a rotational axis X that is perpendicular to the surface over which the walking frame 100 is moving. The wheel mount 124 is rotatable with respect to the walking frame body 110 to change the orientation of the wheel 122 relative to the walking frame body 110 and allow the user to steer the walking frame 100 in different directions across the surface. It will be appreciated that alternative constructions of the wheel 122 and wheel mount 124 are known in the art and may be applied to the walking frame 100 described herein.

The walking frame 100 may comprise an alignment mechanism 130 configured to apply a biasing force to the wheel mount 124 on rotation thereof to bias the wheel 122 into a predetermined orientation relative to the walking frame body 110. In the described embodiment, the predetermined orientation corresponds to the forward direction relative to the walking frame. However, it will be appreciated that, alternatively or additionally, the predetermined orientation may correspond to a direction other than forwards.

The alignment mechanism 130 comprises a plurality of magnets. The alignment mechanism 130 comprises a first magnet 132a coupled to the walking frame body 110 and a second magnet 132b coupled to the wheel mount 124 and configured to rotate therewith.

In the exemplary arrangement shown in FIG. 2A, the first magnet 132a is coupled to the collar 126, which as described above is in turn coupled to the walking frame body 110. The collar 126 may comprise a housing 134 for the first magnet 132a and the wheel mount 124 may comprise a housing 136 for the second magnet 132b. The first magnet 132a and the second magnet 132b are separated by a gap 138 to facilitate relative movement between the first magnet 132a and the second magnet 132b. The skilled person will appreciate that in alternative arrangements, a collar 126 may not be provided, and in such arrangements, the first magnet 132a may be coupled directly to the walking frame body 110.

FIG. 2C shows a close-up schematic diagram of the arrangement of the first magnet 132a and the second magnet 132b. The first magnet 132a and the second magnet 132b are oriented such that their respective magnetic axes are parallel with the rotation axis X. In the arrangement shown in FIGS. 1-2C, the first magnet 132a and the second magnet 132b are aligned with one another such that they are coaxial. That is, their respective magnetic axes are parallel and coincident, as can be seen in FIG. 2C. Furthermore, they are arranged such that opposing poles are aligned with one another. That is, the South pole, S, of the first magnet 132a and the North pole, N, of the second magnet 132b are aligned with, or directed towards, one another. It will be appreciated that first magnet 132a and the second magnet 132b could both be flipped to reverse the direction of their poles, and the equivalent effect would be achieved. The predetermined orientation of the wheel mount 124 may correspond to the first magnet 132a and the second magnet 132b being aligned and/or coaxial.

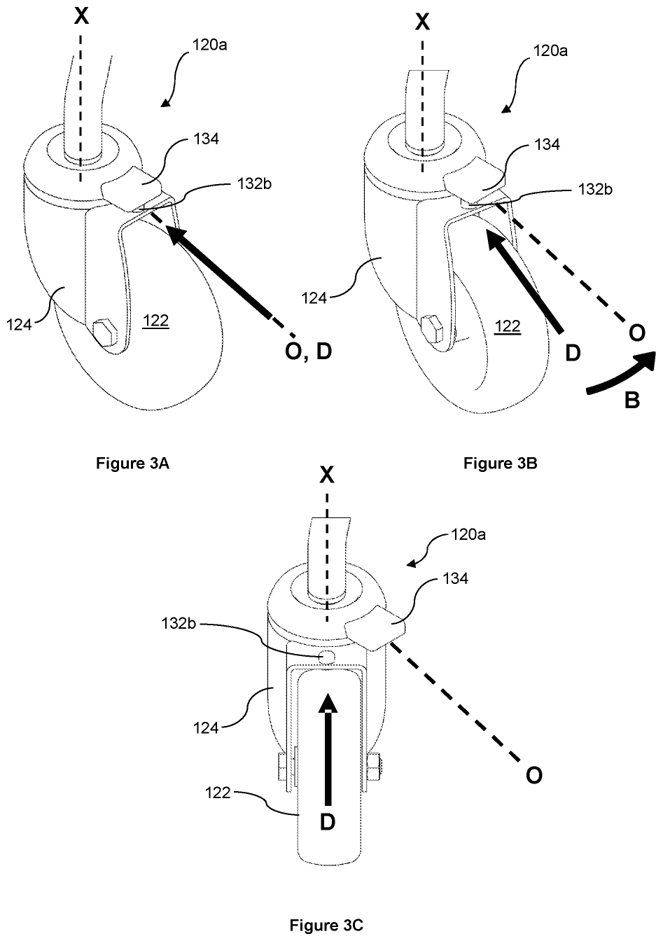

Use of the alignment mechanism 130 as the user walks across a surface supported by the walking frame 100 will now be described with reference to FIGS. 3A-3C. In each of FIGS. 3A-3C, the arrow D represents the direction of travel of the wheel 122, i.e. the direction in which the swivel castor 120a would travel if the walking frame 100 were pushed. The predetermined orientation O is represented by a dashed line. When the wheel 122 is in the predetermined orientation O, the direction D corresponds to the forward direction.

FIG. 3A depicts the swivel castor 120a with the wheel 122 in the predetermined orientation O. The first magnet 132a (not visible, but disposed within housing 134) is aligned with the second magnet 132b. The magnetic interaction between the first magnet 132a and the second magnet 132b provides a biasing force keeping the wheel 122 in the predetermined orientation O while the walking frame 100 is pushed in direction D.

During desired motion in the predetermined orientation O, the wheel mount 124 may inadvertently change direction by a small amount as the user pushes the walking frame 100, and therefore the wheel 122, over the surface. For example, this could be caused by the wheel 122 impacting a small obstacle on the surface, an accidental movement of the user, or a natural oscillatory movement of the wheel mount 124. Such a small movement may be undesirable if the user intends to continue travelling forwards. Advantageously, the alignment mechanism 130 is configured to bias the wheel 122 into the predetermined orientation O. This prevents the user from becoming destabilised by these small movements.

Turning to FIG. 3B, it can be seen that the wheel mount 124 has rotated clockwise by a small amount (e.g. 10 degrees) about the rotation axis X. The direction D of travel is no longer aligned with the predetermined orientation O. That is, the first magnet 132a and the second magnet 132b are no longer aligned coaxially. This rotation may fall within a predetermined rotational range, within which the first magnet 132a and the second magnet 132b still exert an attractive magnetic force on one another. The attractive magnetic force between the magnets 132a, b provides a biasing force, indicated by arrow B. The biasing force B causes the wheel 122 to move back into the predetermined orientation O. The alignment mechanism 130 thereby provides a self-aligning functionality that keeps the wheels 122 in the predetermined orientation O.

If the user wishes to change direction, the user will push the walking frame 100 across the surface to change direction. This will exert a torque on the wheel mount 123 about the rotational axis X. In the case of a minor, accidental movement, the torque is not likely to overcome the biasing force B. However, during a deliberate change of direction, the torque exerted by the user will overcome the biasing force B and rotate the wheel 122 by a larger amount, which may be outside of the predetermined rotational range within which the magnets 132a, 132b exert an attractive force on one another. It is desirable for the user not to experience considerable resistance to a deliberate change of direction, and also to not experience considerable resistance while maintaining the wheel 122 in an orientation that facilitates that change of direction. Advantageously, the alignment mechanism 130 is configured to apply no biasing force B to the wheel mount 124 outside of the predetermined rotational range. As such, the user is not required to exert large amounts of effort to overcome the biasing force once the wheel 122 has been rotated to an orientation outside of the predetermined rotational range.

Turning to FIG. 3C, it can be seen that the wheel mount 124 has rotated clockwise by a larger amount (e.g. 45 degrees) about the rotation axis X than that depicted in FIG. 3B. The direction D of travel is further out of alignment with the predetermined orientation O. The amount of rotation is sufficiently large (i.e. outside of the predetermined rotational range) such that the first magnet 132a and the second magnet 132b no longer exert an attractive magnetic force on one another. There is therefore no longer a biasing force causing the wheel 122 to move back into the predetermined orientation O. While the wheel 122 is outside of the predetermined rotational range, the wheel 122 is free to change direction via rotation of the wheel mount 124, without considerable effort of the user. However, when the wheel 122 returns to being within the predetermined rotational range, the biasing force B returns and assists the user in aligning the wheel 122 in the predetermined orientation O.

It will be appreciated that the size of the predetermined rotational range (i.e. the rotational range over which the magnets 132a, b exert an attractive magnetic force on one another) can be chosen by, for example: adjusting the physical dimensions of the magnets 132a, b; adjusting the strength of the magnets 132a, b; and/or adjusting the number of magnets present. For example, the magnets 132a, b are depicted as having a circular cross-section but, to increase the predetermined rotational range, the magnets 132a, b could be chosen to have a rectangular shape that spans a greater angular distance.

1. A walking frame comprising:
a walking frame body configured to provide support to a user as they walk across a surface;
at least one swivel castor coupled to the walking frame body and comprising:
a wheel configured to contact the surface and rotate as the user pushes the walking frame across the surface; and
a wheel mount rotatable with respect to the walking frame body to change the orientation of the wheel relative to the walking frame body and allow the user to steer the walking frame in different directions across the surface; and
an alignment mechanism configured to apply a biasing force to the wheel mount on rotation thereof to bias the wheel into a predetermined orientation relative to the walking frame body,
wherein the biasing force applied to the wheel mount decreases as the wheel mount rotates away from the predetermined orientation.

2. The walking frame according to claim 1, wherein the alignment mechanism is configured to apply the biasing force to the wheel mount over a predetermined rotational range of the wheel mount.

3. The walking frame according to claim 2, wherein the predetermined rotational range of the wheel mount is less than 360 degrees.

4. The walking frame according to claim 2, wherein the alignment mechanism is configured to apply no biasing force to the wheel mount outside of the predetermined rotational range.

5. The walking frame according to claim 1, wherein the alignment mechanism comprises a plurality of magnets configured to provide the biasing force to bias the wheel mount into the predetermined orientation.

6. The walking frame according to claim 5, wherein the alignment mechanism comprises a first magnet coupled to the walking frame body and a second magnet coupled to the wheel mount and configured to rotate therewith,
wherein relative rotation between the wheel mount and the walking frame body causes the biasing force to be applied to the wheel mount.

7. The walking frame according to claim 6, wherein opposing poles of the first and second magnets are aligned when the wheel mount is in the predetermined orientation.

8. The walking frame according to claim 6, wherein the first and second magnets are coaxial when the wheel mount is in the predetermined orientation.

9. The walking frame according to claim 6, wherein the first and second magnets are coupled to the walking frame body and the wheel mount respectively in a position offset from a rotational axis of the wheel mount.

10. The walking frame according to claim 1 comprising a plurality of swivel castors.

11. The walking frame according to claim 10, wherein the walking frame body comprises front legs and rear legs, and wherein a swivel castor is coupled to each of the front legs and a low-friction glide for sliding over the surface is coupled to each of the rear legs.
